(19) United States
(12) Patent Application Publication
(10) Pub. No.: US 2003/0110224 A1
(43) Pub. Date: Jun. 12, 2003

(54) Message auto-routing for electronic mail

(76) Inventors: Robert Paul Cazier, Fort Collins, CO (US); James W. Owens, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/021,597

(22) Filed: Dec. 12, 2001

(51) Int. Cl. G06F 15/16

(52) U.S. Cl. 709/206; 709/245; 709/207

(57) ABSTRACT

An auto-routing electronic mail (e-mail) system allows intended recipients of bounced previously sent e-mail messages to retrieve their messages, and includes a computer network, a server, and a sender computer. The auto-routing electronic mail system compares a received e-mail message to previously sent e-mail messages. If a match occurs, the e-mail system determines that the previously sent e-mail message is a bounced e-mail message. The e-mail system posts at least a portion of the bounced e-mail message to the server and sends a notification e-mail message to an intended recipient of the bounced e-mail message. The intended recipient may retrieve the bounced e-mail message data from the server.

### FIELD OF THE INVENTION

The present invention relates generally to an electronic mail (e-mail) system, and more particularly to an e-mail system for auto-routing e-mail messages.

### BACKGROUND OF THE INVENTION

Electronic mail (i.e., e-mail) systems are computerized communication systems that send electronic messages over computer networks. E-mail messages are sent at very high speeds and can quickly transmit high amounts of digital data between persons. E-mail messages may include text, video, audio, graphics, etc., or combinations thereof. Some data contents may be very large, such as images and video, for example. Typically, images alone can range in size from ten kilobytes to one megabyte, with even short segments of digital video being much, much larger.

In a prior art approach to e-mail transmission, users may obtain e-mail accounts in order to send and receive e-mail messages. This may include subscription to a commercial e-mail provider. There also exist commercial e-mail providers that induce people to sign up for free e-mail accounts. The provider then pushes advertising at subscribers in return for providing the free e-mail account.

However, there are drawbacks in prior art e-mail systems. The main problem with free e-mail accounts is that they typically do not give users much storage room; only 1 kilobyte of memory space on the provider's e-mail server is not unusual. As a result, users may not be able to receive moderate or large e-mails. Furthermore, a large incoming e-mail message may be bounced by the e-mail server, i.e., it is returned to the sender and not delivered to the intended recipient.

As part of the message bounce, the sender receives an e-mail message telling the sender that the message was not delivered because it exceeded the intended recipient's storage allocation. The intended recipient receives nothing and is not aware that an e-mail delivery was even attempted. Consequently, the sender may have to attempt to transmit the electronic message in some other manner or may have to break the original e-mail message into multiple pieces and transmit the pieces. This is not convenient or acceptable.

Therefore, there remains a need in the art for improvements in electronic mail systems.

### SUMMARY OF THE INVENTION

An auto-routing electronic mail (e-mail) system comprises a computer network, a server, and a sender computer. The auto-routing electronic mail system compares a received message to previously sent e-mail messages. If a match occurs, the e-mail system determines that the received e-mail message is a bounced, previously sent e-mail message. The e-mail system posts at least a portion of the bounced e-mail message to the server and sends a notification e-mail message to an intended recipient of the bounced e-mail message. The intended recipient may retrieve the bounced e-mail message data from the server.

### BRIEF DESCRIPTION OF THE DRAWINGS

FIG. 1 shows an auto-routing e-mail system according to one embodiment of the invention;

FIG. 2 is a flowchart of an e-mail auto-routing method according to one embodiment of the invention;

FIG. 3 is a flowchart of an e-mail auto-routing method according to another embodiment;

FIG. 4 is a flowchart of a bounce detection method according to one embodiment of the invention;

FIG. 5 is a flowchart of a bounce detection method according to another embodiment; and

FIG. 6 is a flowchart of a bounce detection method according to yet another embodiment.

### DETAILED DESCRIPTION

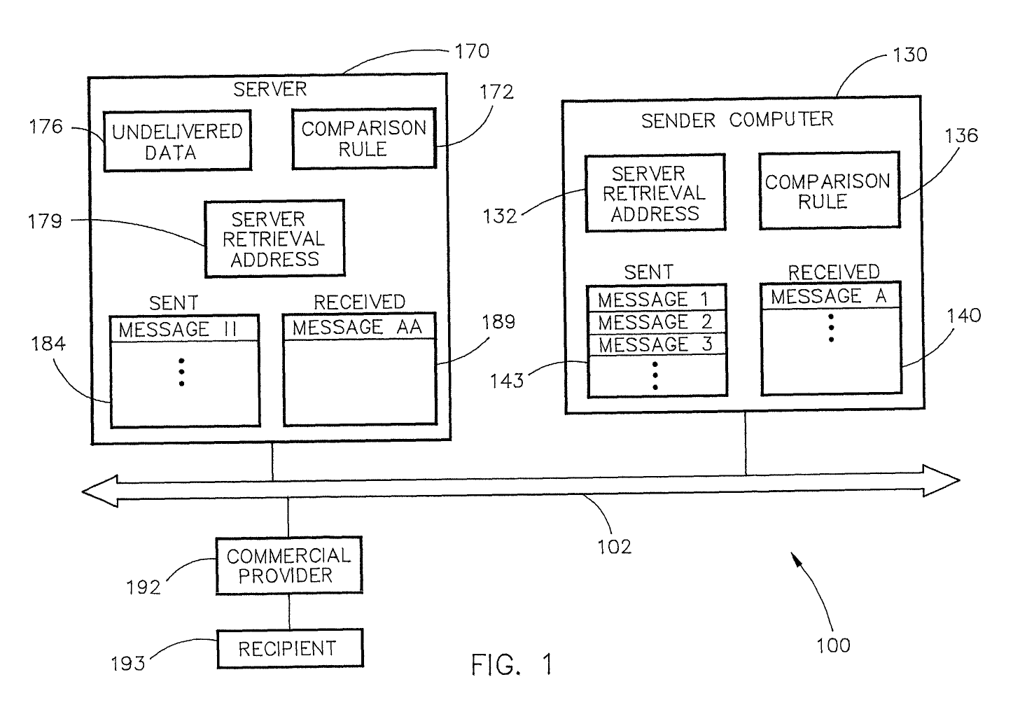

FIG. 1 shows an auto-routing e-mail system 100 according to one embodiment of the invention. The auto-routing e-mail system 100 includes a computer network 102 (such as the Internet, for example), a sender computer 130, a server 170, and a recipient computer 193. The recipient computer 193 may be connected to the computer network 102 through a commercial e-mail service provider 192. The commercial provider 192 may cause incoming messages to be bounced depending on the amount of memory space allocated to the recipient 193. The sender computer 130 may also be connected to the computer network 102 through a commercial provider (not shown).

The commercial provider 192 may be an e-mail service provider that furnishes a free e-mail service to a user in exchange for accepting advertising materials of some manner. However, the commercial provider 192 may be any type of e-mail service provider (even commercial subscription type e-mail service providers may have memory limits and, therefore, message bounce may still occur, although less frequently).

In a first embodiment of the e-mail system 100, a unique software routing application is loaded to the sender computer 130, allowing e-mail message routing according to the invention. In the sender computer based auto-routing, the sender computer 130 includes a server retrieval address 132, a comparison rule 136, a sent message storage 143, and a received message storage 140. These may be portions of a memory of the sender computer 130.

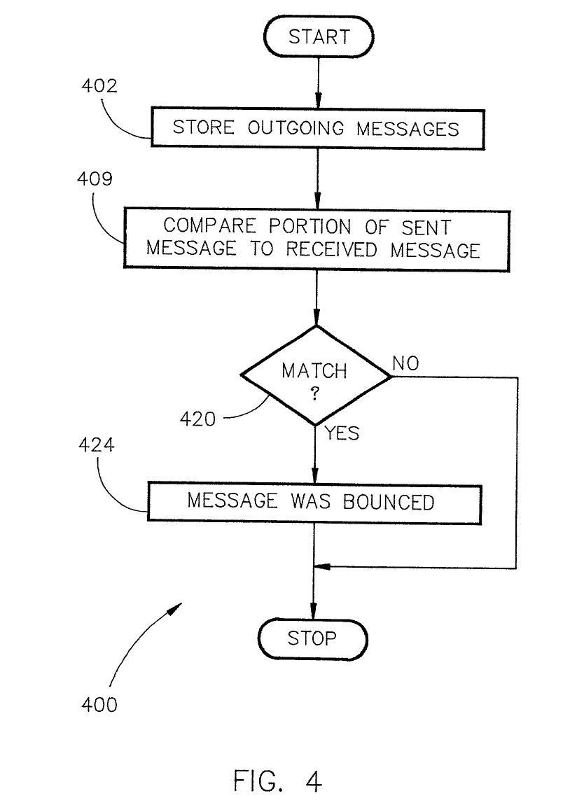

The comparison rule 136 dictates how the sender computer 130 detects a bounced message. The comparison rule 136 may be of several different types, and will be discussed further below in conjunction with FIGS. 4-6.

The sent message storage 143 stores sent e-mail messages. The sent message storage 143 may store each such message for a predetermined period of time and then discard them. Alternatively, the sent message storage 143 may save each such message until the user of the sender computer 130 erases them.

The received message storage 140 likewise stores any received e-mail messages. As in the sent message storage 143, the received message storage 140 may store messages for a predetermined period of time or may store them until the user chooses to delete them.

By comparing the received messages with the previously sent messages and by using the comparison rule 136, the sender computer 130 may detect whether a previously sent message has been bounced. The sender computer 130 therefore may determine whether to auto-route a particular message.

The server 170 in this first e-mail system embodiment includes an undelivered data storage 176 and one or more server retrieval addresses 179. The one or more server retrieval addresses 179 correspond to one or more stored, bounced e-mail messages. Therefore, when the bounced e-mail message is posted (i.e., auto-routed) to the server 170 by the sender computer 130, it is stored in the undelivered data storage 176. A server retrieval address (corresponding to a stored, undelivered e-mail message) is sent by the server 170 to the sender computer 130 and is stored in the server retrieval address storage 132. Furthermore, a notification e-mail message is generated to the intended recipient 193, directing the intended recipient 193 to go to the server 170. The notification e-mail message therefore includes the server retrieval address that was stored in the server retrieval address storage 132. The intended recipient 193 may then retrieve the bounced, previously sent e-mail message from the undelivered data storage 176 (or whatever portion of the bounced e-mail message that was posted to the server 170).

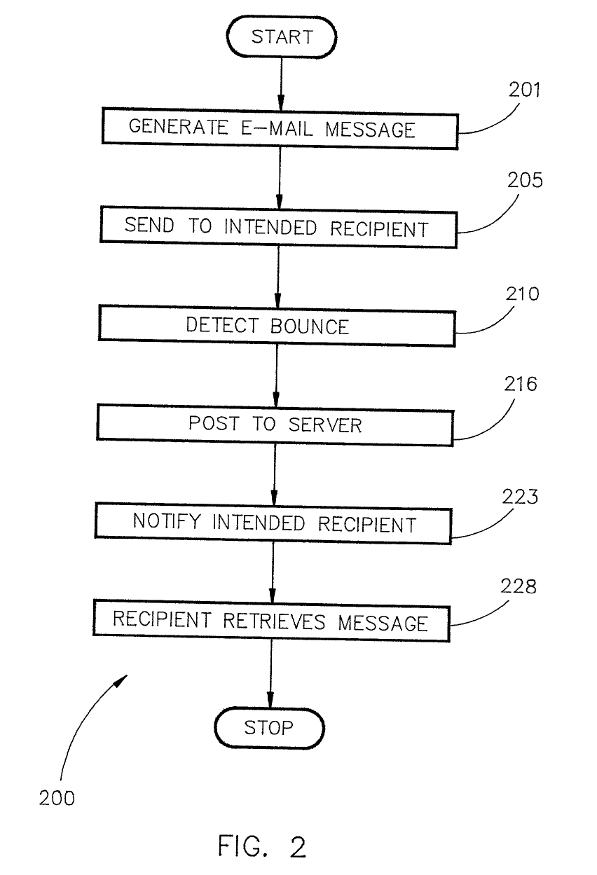

Therefore, in a first method embodiment, the sender computer 130 performs most of the auto-routing functions. The auto-routing of the second e-mail system embodiment is discussed below in conjunction with FIG. 2.

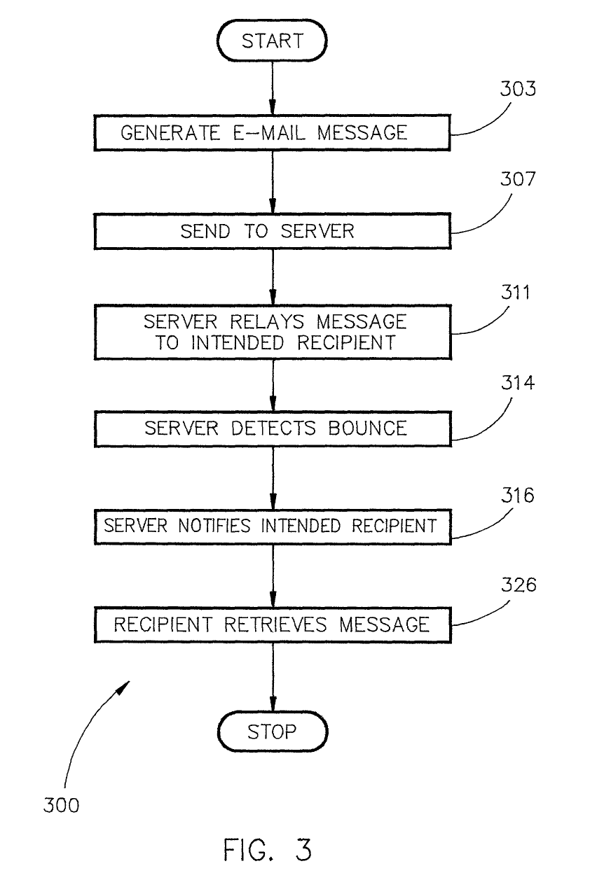

In a second embodiment of the e-mail system 100, the server 170 performs most of the auto-routing functions. The server 170 according to this embodiment includes not only an undelivered data storage 176 and one or more server retrieval addresses 179, but also includes a comparison rule 172, a sent message storage 184, and a received message storage 189. The auto-routing of the second e-mail system embodiment is discussed below in conjunction with FIG. 3.

FIG. 2 is a flowchart 200 of an e-mail auto-routing method according to the first embodiment of the invention. In this method, the sender computer 130 performs most of the auto-routing functions and the server 170 merely holds the bounced e-mail message for the intended recipient 193 to be retrieved. In step 201, the sender computer 130 generates an e-mail message (to be sent to the intended recipient 193).

In step 205, the e-mail message is sent by the sender computer 130 (i.e., an attempt to send the e-mail message). The sender computer 130 retains a copy of the sent e-mail message in the sent message storage 143. The sender computer 130 also stores received e-mail messages in the received message storage 140.

In step 210, the sender computer 130 detects the bounce of the previously sent e-mail message. The sender computer 130 in this embodiment compares a received e-mail to previously sent e-mail messages (this step is discussed in detail below in conjunction with FIGS. 4-6). If there is a match, a bounce is detected.

In step 216, some or all of the bounced e-mail message is posted (auto-routed) to the server 170. For example, the sender computer 130 may post only attachments, may post the body of the e-mail, or may post the entire e-mail message to the server 170.

In step 223, the sender computer 130 sends a notification e-mail message in order to notify the intended recipient 193 of the bounced message. The notification e-mail message may include a message stating that the intended message was bounced, and may inform the intended recipient 193 where to go in order to retrieve the bounced message. For example, the notification e-mail message may include an embedded address, such as an embedded hypertext markup language (HTML) address link or a uniform resource locator (URL) address for the server 170. The notification e-mail message may include a server retrieval address that specifies a location on the server 170 where the auto-routed message is being stored. Therefore, the notification e-mail message includes the server retrieval address as held in the server retrieval address storage 132 (the server retrieval address was provided by the server 170 upon posting of the e-mail message). As a result, the intended recipient 193 may merely click on the embedded address in the notification e-mail to go to the proper location on the server 170.

The embedded address may additionally include embedded account and security information so that the bounced e-mail message may be retrieved only by the intended recipient. The intended recipient therefore will not need to enter the security information but need only to click on the link to go to and enter the appropriate area on the server 170.

In step 228, the intended recipient 193 retrieves the bounced e-mail message from the server 170. The retrieval may take place at any time, and may occur well after the notification e-mail message is received by the intended recipient 193.

The server 170 may automatically delete the bounced e-mail message after it has been retrieved. It should be noted that if the recipient does not retrieve the message, the server 170 may include some manner of predetermined time period after which an unretrieved, bounced e-mail message is discarded.

FIG. 3 is a flowchart 300 of an e-mail auto-routing method according to another embodiment of the invention. In this second method embodiment, the server 170 performs most of the auto-routing functions, including the bounce detection and the notification. The user computer 130 merely generates the original e-mail message and passes it to the server 170 (as a proxy server). Therefore, in this method there is no need for the sender computer 130 to load new software in order to obtain or employ message auto-routing. A user may obtain the auto-routing capability merely by subscribing to the server 170.

In step 303, the sender computer 130 generates an e-mail message, as before.

In step 307, the sender computer 130 sends the original, sender-computer generated e-mail message directly to the server 170.

In step 311, the server relays the message to the intended recipient 193 (i.e., attempts to send it). The server 170 also stores a copy of the sent message in the sent message storage 184. The server 170 likewise stores any received messages in the received message storage 184.

In step 314, the server 170 detects a bounce of the e-mail message. In contrast to the first method embodiment, in this second method embodiment the server 170 compares all received messages (for each sender) to the sent messages in order to detect a bounce. This is done according to the comparison rule 172, as will be discussed below in conjunction with FIGS. 4-6. If there is a match, a bounce is detected.

In step 316, the server 170 sends a notification e-mail message to the intended recipient 193 in order to notify the intended recipient 193 of the bounce and to inform where on the server 170 the bounced e-mail message may be found. The notification e-mail message therefore instructs the intended recipient 193 that the bounced e-mail message can be retrieved from the undelivered data storage 176 on the server 170.

In step 326, the recipient retrieves the bounced e-mail message from the undelivered data storage 176. When the intended recipient 193 has retrieved the bounced e-mail message, the server 170 may erase it. In addition, there may be a time limit on retention, after which the server 170 will automatically discard the message.

In this embodiment, the server 170 may be part of a subscription service. In such a subscription service, the sender may pay for the use of the server 170. Alternatively, the message auto-routing may be incorporated into and may be a feature of a subscription e-mail provider. The subscription may be a periodic subscription or may be available on a pay-per-use basis. In addition, the server 170 may be a service provider that provides the message auto-routing as part of a service, such as a charge for printed images wherein the auto-routed e-mail message contains digital photographs.

FIG. 4 is a flowchart 400 of a bounce detection method according to one embodiment of the invention. This bounce detection method may be performed by either the sender computer 130 or by the server 170. In step 402, outgoing e-mail messages are stored. This may be the storage of all outgoing messages in the sent message storage 143 of the sender computer 130 or in the sent message storage 184 of the server 170.

In step 409, a portion of the stored sent message is compared to a received message in order to detect a bounce. This may be a portion of the body of the previously sent e-mail message, the “to” and “from” addresses, etc. The step may compare only a portion of messages in order to streamline this matching. Alternatively, the entire message may be compared.

In step 420, if a match is detected, the method proceeds to 424; otherwise the method exits.

In step 424, because a match was detected, the method determines that the previously sent e-mail message was bounced.

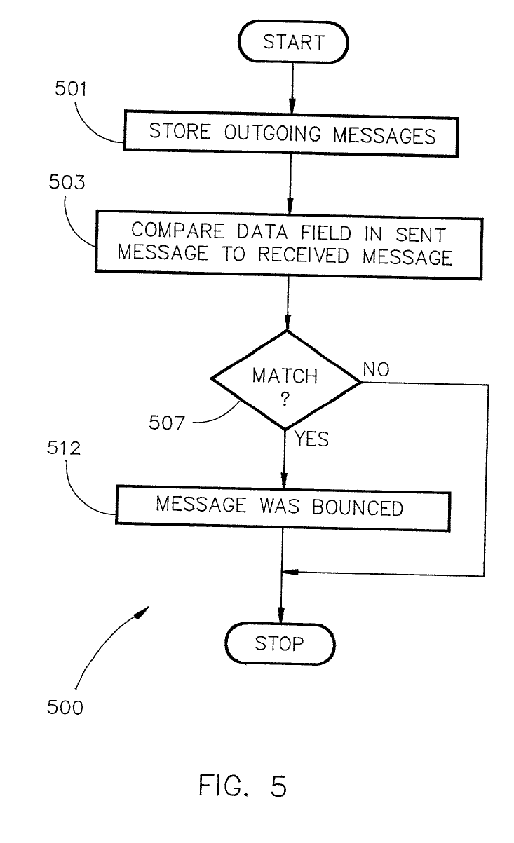

FIG. 5 is a flowchart 500 of a bounce detection method according to another embodiment of the invention. Again, this bounce detection method may be performed in either the sender computer 130 or in the server 170. In step 501, outgoing e-mail messages are stored. This may be the storage of all outgoing messages in the sent message storage 143 of the sender computer 130 or in the sent message storage 184 of the server 170.

In step 503, a data field in a previously sent e-mail message is compared to a corresponding data field in a received e-mail message. The data fields may be, for example, a “to” address data field, a “from” address data field, a subject data field, etc.

In step 507, if a match is detected, the method proceeds to step 512; otherwise it exits.

In step 512, because the compared data fields have matched, the method determines that the previously sent e-mail message was bounced.

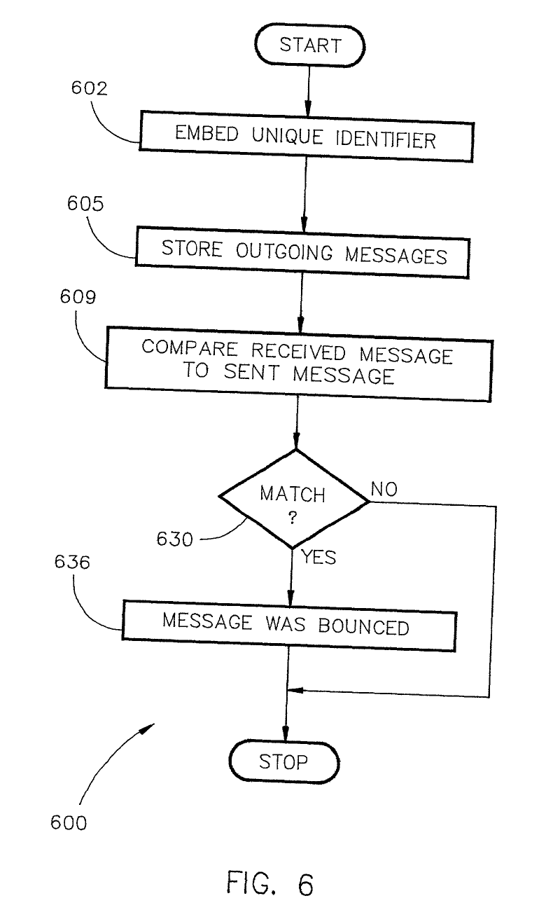

FIG. 6 is a flowchart 600 of a bounce detection method according to yet another embodiment of the invention. Again, this bounce detection method may be performed in either the sender computer 130 or in the server 170. In step 602, a unique identifier is embedded in each outgoing (sent) message. The identifier may be a random number or a serial number generated by the sender computer 130 or server 170, as appropriate. Alternatively, the unique identifier may be a time stamp, which is already embedded in most e-mails.

In step 605, outgoing e-mail messages are stored. This may be the storage of all outgoing messages in the sent message storage 143 of the sender computer 130 or in the sent message storage 184 of the server 170.

In step 609, a unique identifier in a received e-mail message is compared to a unique identifier in a previously sent e-mail message.

In step 630, if a match is detected, the method proceeds to step 636; otherwise it exits.

In step 636, because the unique identifiers have matched, the method determines that the previously sent e-mail message was bounced.

The message auto-routing according to the invention may apply to any e-mail system. The message auto-routing may work with any e-mail provider on the recipient's part, but is especially useful if the recipient has only a small amount of memory space on a server of the e-mail provider. It may also be helpful in a situation where an intended recipient is experiencing problems and cannot receive e-mail. Furthermore, it is especially useful in situations where the sender is sending large e-mail messages, such as e-mail messages containing one or more still images or e-mail messages containing video.

The invention differs from the prior art by acting as an intermediary and temporarily storing data until the intended recipient is able to retrieve it. The invention differs from the prior art in that the invention overcomes any space limitations on the part of the recipient. Furthermore, the invention allows an intended recipient to be notified of a message bounce, and gives the intended recipient an opportunity to retrieve the bounced message. Therefore, the invention advantageously accommodates any size of e-mail message and allows a recipient to retrieve a message at the recipient's leisure.

We claim:

1. An auto-routing electronic mail (e-mail) system, comprising:
a computer network;
a server communicating over said computer network and including an undelivered data storage; and
a sender computer communicating over said computer network;
wherein said electronic mail system compares a received e-mail message to previous e-mail messages sent from said sender computer and if a match occurs said e-mail system determines that said received e-mail message is a bounced e-mail message, and wherein said e-mail system posts at least a portion of said bounced e-mail message to said undelivered data storage in said server and sends a notification e-mail message to an intended recipient of said bounced e-mail message, notifying said intended recipient of the existence of said bounced e-mail message and instructing said intended recipient as to how to retrieve said bounced e-mail message.

2. The system of claim 1, wherein said computer network further comprises a plurality of inter-connected computer networks.

3. The system of claim 1, wherein said notification e-mail includes a server retrieval address comprising a hypertext markup language (HTML) address link identifying the location of said bounced e-mail message in said undelivered data storage.

4. The system of claim 1, wherein said notification e-mail includes a server retrieval address comprising a uniform resource locator (URL) address identifying the location of said bounced e-mail message in said undelivered data storage.

5. The system of claim 1, said sender computer further comprising:
a sent message storage storing previously sent e-mail messages;
a received message storage storing received e-mail messages;
a server retrieval address storage storing a server retrieval address of at least a portion of a bounced e-mail message posted to said server; and
a comparison rule that governs how a bounce is detected;
wherein said sender computer compares a received message to said previously sent e-mail messages according to said comparison rule, determines whether said received message was bounced, posts said at least a portion of said bounced e-mail message to said server, and sends said notification e-mail message to said intended recipient.

6. The system of claim 5, wherein said sender computer receives a server retrieval address from said server after said at least a portion of said bounced e-mail message is posted to said server, with said server retrieval address being included in said notification e-mail message.

7. The system of claim 1, said server further comprising:
a sent message storage storing previously sent e-mail messages;
a received message storage storing received e-mail messages; and
a comparison rule that governs how a bounce is detected;
wherein said server compares a received message to said previously sent messages according to said comparison rule, determines whether said received message was bounced, and sends said notification e-mail message to said intended recipient.

8. The system of claim 7, wherein said server transmits a server retrieval address to said intended recipient after a message bounce is detected, with said server retrieval address being included in said notification e-mail message.

9. An auto-routing method for an electronic mail (e-mail) system, comprising the steps of:
determining if a received e-mail message is a bounced e-mail message;
posting at least a portion of said bounced e-mail message to a server accessible to an intended recipient of said bounced e-mail message; and
notifying said intended recipient of an availability of said at least a portion of said bounced e-mail message on said server;
wherein said intended recipient accesses said server in order to obtain said at least a portion of said bounced e-mail message.

10. The method of claim 9, wherein said server performs the determining and notifying steps.

11. The method of claim 9, further comprising the preliminary steps of:
said sender computer transmitting a generated e-mail message to said data server; and
said data server relaying said generated e-mail message to said intended recipient;
wherein said server performs the determining and notifying steps.

12. The method of claim 9, wherein a sender computer performs the determining and notifying steps.

13. The method of claim 9, the notifying step further comprising sending a notification e-mail message to said intended recipient.

14. The method of claim 9, the notifying step further comprising embedding an HTML address link in a notification e-mail message.

15. The method of claim 9, the notifying step further comprising embedding a URL address in a notification e-mail message.

16. The method of claim 9, the determining step further comprising the steps of:
embedding a unique identifier in each outgoing e-mail message;
comparing a previously sent message unique identifier to a received message unique identifier; and
determining that said previously sent message was bounced if a match is found.

17. The method of claim 9, the determining step further comprising the steps of:
comparing at least a portion of said previously sent message to a corresponding portion of a received e-mail message; and
determining that said previously sent message was bounced if a match is found.

18. The method of claim 9, the determining step further comprising the steps of:
maintaining a queue of outgoing messages with each message in said queue being stored for a predetermined time period;
comparing at least a portion of said previously sent message to a corresponding portion of a received e-mail message; and
determining that said previously sent message was bounced if a match is found.

19. The method of claim 9, the determining step further comprising the steps of:
comparing one or more predetermined data fields in said previously sent message to one or more corresponding data fields in a received e-mail message; and
determining that said previously sent message was bounced if a match is found.
